(19) United States
(12) Patent Application Publication
(10) Pub. No.: US 2015/0145849 A1
(43) Pub. Date: May 28, 2015

(54) Display With Threshold Voltage Compensation Circuitry

(71) Applicant: Apple Inc., Cupertino, CA (US)

(72) Inventors: Jae Won Choi, Cupertino, CA (US); Shih Chang Chang, Cupertino, CA (US); Tsung-Ting Tsai, Taipei (TW); Vasudha Gupta, Cupertino, CA (US); Young Bae Park, San Jose, CA (US)

(21) Appl. No.: 14/444,581

(22) Filed: Jul. 28, 2014

Related U.S. Application Data
(60) Provisional application No. 61/909,010, filed on Nov. 26, 2013.

(51) Int. Cl. G09G 3/32

(52) U.S. Cl. CPC G09G 3/3233; G09G 2300/0819; G09G 2300/0866; G09G 2320/0219
USPC 345/212; 345/76

(57) ABSTRACT

A display may have an array of organic light-emitting diode display pixels. Each display pixel may have a light-emitting diode that emits light under control of a drive transistor. Each display pixel may also have control transistors for compensation and programming operations. Each display pixel may have five p-type transistor and two capacitors. One of the five p-type transistors may serve as the drive transistor and may be compensated using the remaining four of the p-type transistors and the two capacitors. A first of the capacitors may be coupled between the gate and source of the drive transistor. A second of the capacitors may have a terminal coupled to the source. Alternatively, each display pixel may have six p-type transistors and a single capacitor. The six p-type transistors may include a drive transistor having a gate coupled to the capacitor.

This application claims the benefit of provisional patent application No. 61/909,010, filed Nov. 26, 2013, which is hereby incorporated by reference herein in its entirety.

### BACKGROUND

This relates generally to electronic devices with displays and, more particularly, to display driver circuitry for displays such as organic-light-emitting diode displays.

Electronic devices often include displays. For example, cellular telephones and portable computers include displays for presenting information to users.

Displays such as organic light-emitting diode displays have an array of display pixels based on light-emitting diodes. In this type of display, each display pixel includes a light-emitting diode and thin-film transistors for controlling application of a signal to the light-emitting diode to produce light.

Threshold voltage variations in the thin-film transistors can cause undesired visible display artifacts. For example, threshold voltage hysteresis can cause white pixels to be displayed differently depending on context. The white pixels in a frame may, as an example, be displayed accurately if they were preceded by a frame of white pixels, but may be displayed inaccurately (i.e., they may have a gray appearance) if they were preceded by a frame of black pixels. This type of history-dependent behavior of the light output of the display pixels in a display causes the display to exhibit a low response time. To address the issues associated with threshold voltage variations, displays such as organic light-emitting diode displays are provided with threshold voltage compensation circuitry. Such circuitry may not, however, adequately address all threshold voltage variations, may not satisfactorily improve response times, and may have a design that is difficult to implement.

It would therefore be desirable to be able to provide a display with improved threshold voltage compensation circuitry.

### SUMMARY

An electronic device may include a display having an array of display pixels. The display pixels may be organic light-emitting diode display pixels. Each display pixel may have an organic light-emitting diode that emits light and a drive transistor that controls the application of current to the organic light-emitting diode. The drive transistor has an associated threshold voltage.

Each display pixel may have control transistors for threshold voltage compensation operations. During compensation operations, the control transistors are controlled so as to compensate the drive transistor for variations in the threshold voltage of the drive transistor. This ensures that the output of the light-emitting diode will be responsive to the size of the data signal loaded into the display pixel and independent of threshold voltage.

With one arrangement, each display pixel has five p-type transistor and two capacitors. One of the five p-type transistors serves as the drive transistor for the display pixel and may be compensated using the remaining four of the p-type transistors and the two capacitors. A first of the capacitors may be coupled between the drain and source of the drive transistor. A second of the capacitors may have a terminal coupled to the drain.

With another arrangement, each display pixel has six p-type transistors and a single capacitor. The six p-type transistors include a p-type drive transistor having a gate coupled to the capacitor.

### BRIEF DESCRIPTION OF THE DRAWINGS

FIG. 1 is a diagram of an illustrative display such as an organic light-emitting diode display having an array of organic light-emitting diode display pixels in accordance with an embodiment.

FIG. 2 is a diagram of an illustrative organic light-emitting diode display pixel of the type that may be used in a display in accordance with an embodiment.

FIG. 3 is a timing diagram showing signals involved in operating the display pixel circuitry of FIG. 2 in accordance with an embodiment.

FIG. 4 is a diagram of another illustrative organic light-emitting diode display pixel of the type that may be used in a display in accordance with an embodiment.

FIG. 5 is a timing diagram showing signals involved in operating the display pixel circuitry of FIG. 4 in accordance with an embodiment.

### DETAILED DESCRIPTION

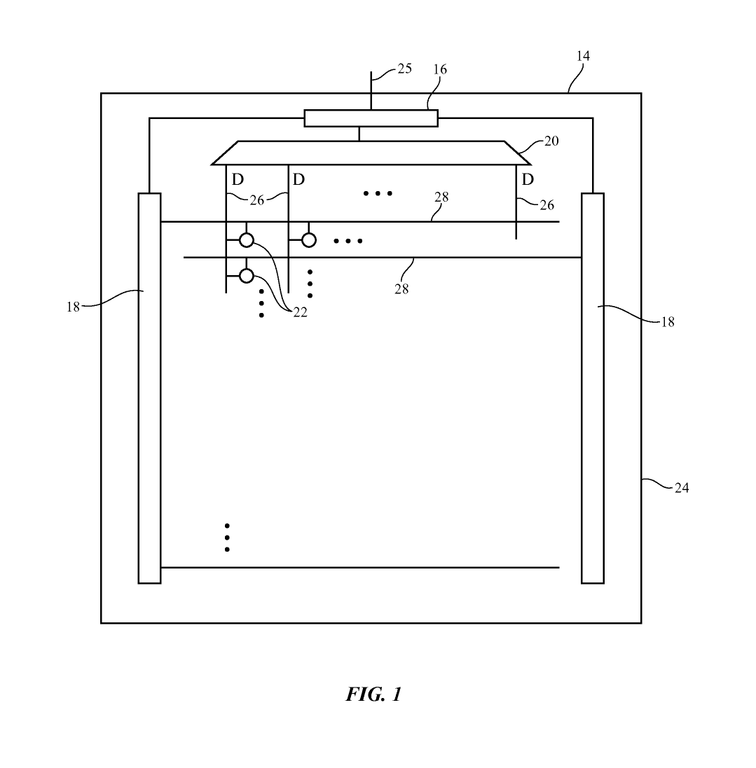

A display in an electronic device may be provided with driver circuitry for displaying images on an array of display pixels. An illustrative display is shown in FIG. 1. As shown in FIG. 1, display 14 may have one or more layers such as substrate 24. Layers such as substrate 24 may be formed from planar rectangular layers of material such as planar glass layers. Display 14 may have an array of display pixels 22 for displaying images for a user. The array of display pixels 22 may be formed from rows and columns of display pixel structures on substrate 24. These structures may include thin-film transistors such as polysilicon thin-film transistors, semiconducting oxide thin-film transistors, etc. There may be any suitable number of rows and columns in the array of display pixels 22 (e.g., ten or more, one hundred or more, or one thousand or more).

Display driver circuitry such as display driver integrated circuit 16 may be coupled to conductive paths such as metal traces on substrate 24 using solder or conductive adhesive. Display driver integrated circuit 16 (sometimes referred to as a timing controller chip) may contain communications circuitry for communicating with system control circuitry over path 25. Path 25 may be formed from traces on a flexible printed circuit or other cable. The system control circuitry may be located on a main logic board in an electronic device such as a cellular telephone, computer, television, set-top box, media player, portable electronic device, or other electronic equipment in which display 14 is being used. During operation, the control circuitry may supply display driver integrated circuit 16 with information on images to be displayed on display 14. To display the images on display pixels 22, display driver integrated circuit 16 may supply clock signals and other control signals to display driver circuitry such as row driver circuitry 18 and column driver circuitry 20. Row driver circuitry 18 and/or column driver circuitry 20 may be formed from one or more integrated circuits and/or one or more thin-film transistor circuits on substrate 24.

Row driver circuitry 18 may be located on the left and right edges of display 14, on only a single edge of display 14, or elsewhere in display 14. During operation, row driver circuitry 18 may provide row control signals on horizontal lines 28 (sometimes referred to as row lines or scan lines). Row driver circuitry may sometimes be referred to as scan line driver circuitry.

Column driver circuitry 20 may be used to provide data signals D from display driver integrated circuit 16 onto a plurality of corresponding vertical lines 26. Column driver circuitry 20 may sometimes be referred to as data line driver circuitry or source driver circuitry. Vertical lines 26 are sometimes referred to as data lines. During compensation operations, column driver circuitry 20 may use paths such as vertical lines 26 to supply a reference voltage. During programming operations, display data is loaded into display pixels 22 using lines 26.

Each data line 26 is associated with a respective column of display pixels 22. Sets of horizontal signal lines 28 run horizontally through display 14. Power supply paths and other lines may also supply signals to pixels 22. Each set of horizontal signal lines 28 is associated with a respective row of display pixels 22. The number of horizontal signal lines in each row may be determined by the number of transistors in the display pixels 22 that are being controlled independently by the horizontal signal lines. Display pixels of different configurations may be operated by different numbers of control lines, data lines, power supply lines, etc.

Row driver circuitry 18 may assert control signals on the row lines 28 in display 14. For example, driver circuitry 18 may receive clock signals and other control signals from display driver integrated circuit 16 and may, in response to the received signals, assert control signals in each row of display pixels 22. Rows of display pixels 22 may be processed in sequence, with processing for each frame of image data starting at the top of the array of display pixels and ending at the bottom of the array (as an example). While the scan lines in a row are being asserted, the control signals and data signals that are provided to column driver circuitry 20 by circuitry 16 direct circuitry 20 to demultiplex and drive associated data signals D onto data lines 26 so that the display pixels in the row will be programmed with the display data appearing on the data lines D. The display pixels can then display the loaded display data.

In an organic light-emitting diode display such as display 14, each display pixel contains a respective organic light-emitting diode for emitting light. A drive transistor controls the amount of light output from the organic light-emitting diode. Control circuitry in the display pixel is configured to perform threshold voltage compensation operations so that the strength of the output signal from the organic light-emitting diode is proportional to the size of the data signal loaded into the display pixel while being independent of the threshold voltage of the drive transistor.

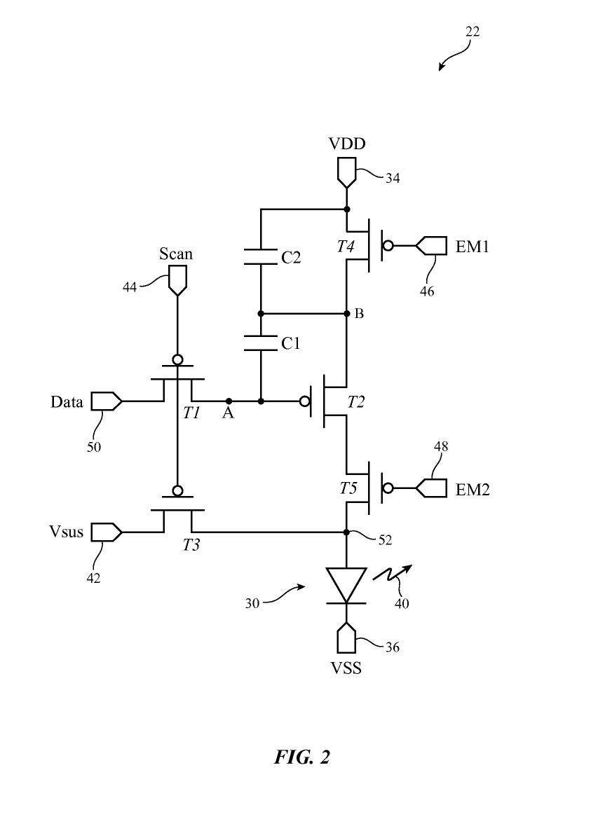

A schematic diagram of an illustrative organic light-emitting diode display pixel 22 in display 14 is shown in FIG. 2. Display pixel 22 of FIG. 2 has storage capacitors C1 and C2 and transistors such as p-type transistors T1, T2, T2, T3, T4, and T5. The transistors of pixel 22 may be thin-film transistors formed from a semiconductor such as polysilicon, indium gallium zinc oxide, etc.

As shown in FIG. 2, display pixel 22 may include light-emitting diode 30. A positive power supply voltage Vdd may be supplied to positive power supply terminal 34 and a ground power supply voltage Vss (e.g., 0 volts or other suitable voltage) may be supplied to ground power supply terminal 36. The state of drive transistor T2 controls the amount of current flowing from terminal 34 to terminal 36 through diode 30 and therefore the amount of emitted light 40 from display pixel 22.

Terminal 42 is used to supply a negative voltage (e.g., −1 V or −2 V or other suitable voltage) to assist in turning off diode 30 when diode 30 is not in use. Control signals from display driver circuitry such as row driver circuitry 18 of FIG. 1 are supplied to control terminals such as terminals 44, 46, and 48. A data input terminal such as data signal terminal 50 is coupled to a respective data line 26 of FIG. 1 for receiving image data for display pixel 22. Control signal SCAN is applied to scan terminal 44. Emission control signals EM1 and EM2 are supplied to terminals 46 and 48, respectively.

Each display pixel such as display pixel 22 of FIG. 2 is operated in four repeating Phases—initialization, threshold voltage compensation, data input, and emission. During initialization, threshold voltage compensation, and data input operations, the control circuitry of display pixel 22 is used to establish a control voltage on the gate of drive transistor T2 that is independent of the threshold voltage Vth of drive transistor T2 and that is proportional to the magnitude of a data signal D that has been loaded into the display pixel from an associated data line 26 and terminal 50. During the subsequent emission phase, drive transistor T2 drives a corresponding current through light-emitting diode 30 so that an appropriate amount of light 40 is emitted by display pixel 22. An entire row of display pixels may be compensated and loaded with data at the same time and this process repeated for each row in the display so that all rows are compensated and loaded in this way for each frame of data or other suitable control schemes can be used for the display pixels of display 14.

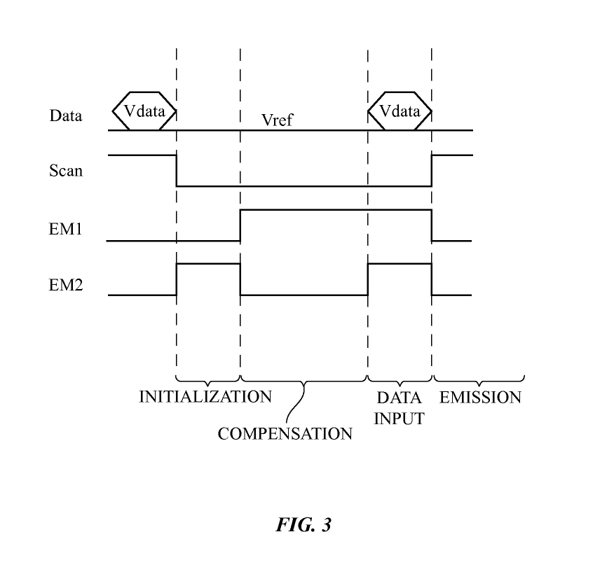

FIG. 3 is a timing diagram showing the states of signals that may be applied to each display pixel 22 of FIG. 2 during the four phases of operation per image frame: 1) initialization, 2) compensation, 3) data input, and 4) emission.

During initialization, control signal SCAN is taken low to turn on transistors T1 and T3, control signal EM1 is taken low to turn on drive transistor T4, and control signal EM2 is taken high to turn off transistor T5. Data terminal 50 is provided with a reference voltage Vref by the display driver circuitry of display 14 (e.g., circuitry 20 of FIG. 1). Under these conditions, node B is shorted to power supply terminal 34 so node B is taken to power supply voltage Vdd. Because transistor T1 is turned on, reference voltage Vref from terminal 50 is driven onto node A. Transistor T5 is off, so organic light-emitting diode 30 is isolated from drive transistor T2 and does not emit light 40. To ensure that organic light-emitting diode 30 is turned off and does not emit light, negative (suspend) voltage Vsus is applied to node 52 to reverse bias diode 30. This reverse bias may be applied to diode 30 during the initialization phase, the compensation phase, and the data input phase.

At the completion of the initialization phase, the voltage on node A is Vref and the voltage on node B is Vdd.

After initialization operations are complete, threshold voltage compensation operations are performed. During compensation operations, reference voltage Vref continues to be applied to data line 50. Control signal SCAN continues to be held low to turn on transistor T1 and T3. Control signal EM1 is taken high to turn off transistor T4. Transistor T2 is on because node A is at voltage Vref. With transistors T2, T5, and T3 on, a current discharge path is formed from node B to terminal 42 at voltage Vsus. As a result, the voltage at node B drops until the gate-source voltage Vgs of transistor T2 is equal to the threshold voltage of transistor T2. At the completion of the threshold voltage compensation phase, the voltage on node A is Vref and the voltage on node B at the source of drive transistor T2 is Vref+|Vth|.

After compensation operations are complete, data input operations are performed. During data input operations, valid image data D (of voltage Vdata) for display pixel 22 is supplied to node A via the data line 26 that is coupled to data input line 50. Transistor T5 is turned off by taking control signal EM2 high, so node B is isolated and is floating. In this situation, capacitive coupling through capacitors C1 and C2 from node A to node B causes the voltage at node B to rise by a voltage ΔV, where ΔV=(C1/(C1+C2))*(Vdata−Vref). At the completion of data input operations, node A is therefore at Vdata and node B is at Vref+|Vth|+ΔV.

After data input operations, emission operations are performed. During emission operations, control signal SCAN is taken high to turn off transistors T1 and T3. Control signal EM1 and control signal EM2 are taken low to turn on transistors T4 and T5, respectively. With transistor T3 off, the terminal of diode 30 that is coupled to node 52 is isolated from voltage Vsus. With transistor T1 off, data terminal 50 is isolated from node A. Because transistor T4 is on, power supply voltage Vdd is driven onto node B. Due to capacitive coupling from node B to node A, the voltage at node A is taken to Vdata+Vdd−Vref−|Vth|−ΔV. In other words, as the voltage on node B is changed by an amount equal to Vdd−Vref−|Vth|−ΔV, the voltage on node A changes by an equal amount, because the voltage across capacitor C1 does not change instantaneously. With these voltages established on nodes A and B, the drive current Id through drive transistor T2 is given by Id=k (Vref−Vdata+ΔV)². Substituting for AV, we obtain Id=[(C2/(C1+C2))*(Vdata−Vref)]². As this equation demonstrates, the magnitude of drive current Id is proportional to the magnitude of data signal Vdata and is independent of threshold voltage Vth (i.e., compensation operations have been successfully performed, so that light emission is not affected by Vth variations).

Simulations have been performed to evaluate the operation of the circuit of FIG. 2. These simulations indicate that light output 40 of light-emitting diodes such as diode 30 of FIG. 2 will not be significantly affected by drive transistor threshold voltage hysteresis and response time for display 14 will therefore be satisfactory. The output magnitude of a white pixel (as one example) will be substantially the same regardless of whether the state of the pixel was black in the prior frame or was white in the prior frame.

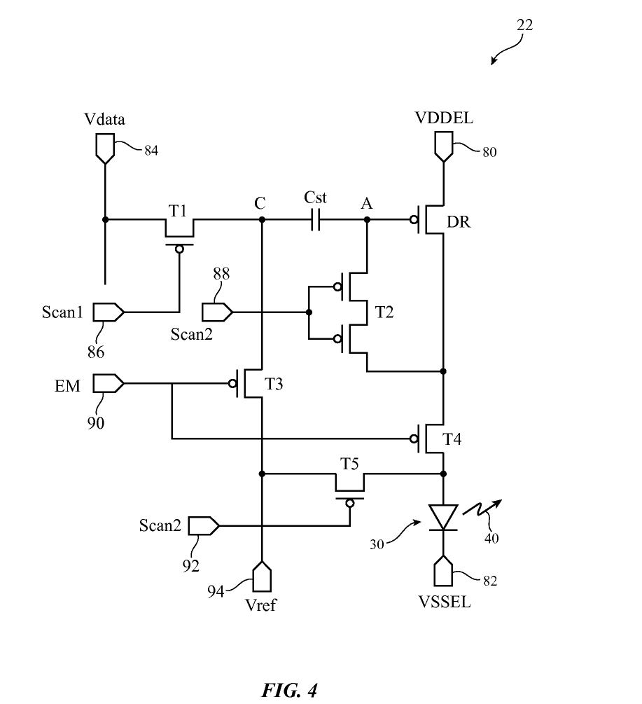

Another illustrative circuit that may be used for controlling the operation of display pixels 22 in display 14 of FIG. 1 is shown in FIG. 4. In the circuit of FIG. 4, positive power supply voltage Vddel is supplied to terminal 80 and ground power supply voltage Vssel (e.g., 0 volts or other suitable voltage) is supplied to terminal 82. A data line 26 of FIG. 1 is coupled to data input terminal 84. Reference voltage Vref is supplied to terminal 94. Control signal SCAN1 is supplied to terminal 86. Control signal SCAN2 is supplied to terminals 88 and 92. Control signal EM is supplied to terminal 90. Storage capacitor Cst has a terminal that is connected to the gate of drive transistor DR at node A and has a terminal that is connected to node C.

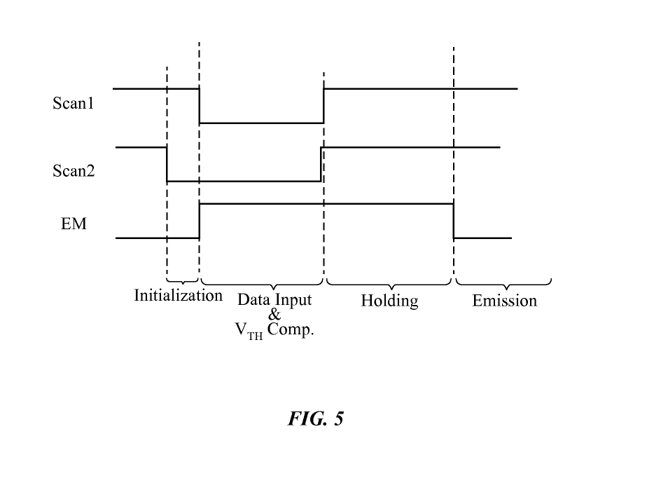

FIG. 5 is a timing diagram that shows signals associated with controlling the operation of the circuitry of FIG. 4 during four phases: 1) initialization, 2) data input and threshold voltage compensation, 3) holding, and 4) emission.

During initialization, control signal SCAN1 is taken high to turn off transistor T1, thereby isolating node C from data input line 84. Control signal SCAN2 and control signal EM are taken low to turn on transistors T3, T5, T4, and T2. With transistor T3 on, voltage Vref is driven onto node C from terminal 94. With transistors T5, T4, and T2 on, voltage Vref is driven onto node A from terminal 94. At the end of the initialization phase, node A and node C are therefore both at voltage Vref. With node A and node C reset to Vref, the voltage across capacitor Cst is 0 volts.

After initialization operations are complete, data input and threshold voltage compensation operations are performed. Control signal EM is taken high to turn off transistors T3 and T4. Control signal SCAN1 is taken low to turn on transistor T1 and drive data signal Vdata onto node C (i.e., valid pixel data is loaded onto node C). Because T2 is on, the drain of drive transistor DR is shorted to the gate of drive transistor DR, placing transistor DR in a diode configuration. In the diode configuration, the source-gate voltage of transistor DR is equal to the threshold voltage Vth of drive transistor DR. Accordingly, the voltage on node A is taken to power supply voltage Vddel−|Vth|. At the end of the data input and threshold voltage compensation phase, the voltage on node A is therefore Vddel−|Vth| and the voltage on node C is Vdata.

After the data input and threshold voltage compensation phase is complete, holding phase operations are performed. During the holding phase, control signals SCAN1, SCAN2, and EM are all taken high to turn off all transistors T1, T2, T3, T4, and T5, and thereby hold the values of the voltages on nodes A and C at Vddel−|Vth| and Vdata, respectively.

After the holding phase is complete, emission operations are performed. During the emission phase, control signals SCAN1 and SCAN2 are held high to maintain transistors T1, T2, and T5 in their off states. Control signal EM is taken low to take transistor T3 on. Because transistor T2 is off, node A is floating. Because transistor T3 is on, reference voltage Vref is driven onto node C. Through capacitive coupling from node C to node A, the voltage at node A is taken to Vddel−|Vth|+Vref−Vdata. With the voltage at node A at Vddel−|Vth|+Vref−Vdata and the voltage at node C at Vref, the drive current Id through drive transistor DR into organic light-emitting diode 30 is given by: Id=k (Vddel−Vddel+|Vth|−Vref+Vdata−|Vth|)². Simplifying this equation we obtain Id=k(Vdata−Vref), which is proportional to data signal Vdata and independent of threshold voltage Vth.

Simulations have been performed on the circuit of FIG. 4. The result of these simulations indicate that the light output 40 of light-emitting diodes such as diode 30 of FIG. 4 will not be significantly affected by drive transistor threshold voltage hysteresis, so display response time will be satisfactory. In the absence of threshold voltage hysteresis effects, the output magnitude of a white pixel (as an example) will be substantially the same regardless of whether the state of the pixel was black in the prior frame or was white in the prior frame.

The foregoing is merely illustrative and various modifications can be made by those skilled in the art without departing from the scope and spirit of the described embodiments. The foregoing embodiments may be implemented individually or in any combination.

What is claimed is:

1. A display pixel, comprising:
an organic light-emitting diode;
first, second, third, fourth, and fifth transistors, wherein the second transistor is a drive transistor that has a threshold voltage and that supplies a current to the organic light-emitting diode; and
first and second capacitors, wherein the first, third, fourth, and fifth transistors receive control signals during operation of the display pixel that compensate for variations in the threshold voltage of the drive transistor.

2. The display pixel defined in claim 1 wherein the first, third, fourth, and fifth transistors are p-type transistors.

3. The display pixel defined in claim 2 wherein the drive transistor is a p-type transistor.

4. The display pixel defined in claim 3 wherein the drive transistor has a gate and a source, wherein a first of the two capacitors is coupled between the gate and the source, and wherein a second of the two capacitors has a terminal connected to the source.

5. The display pixel defined in claim 1 further comprising a data input terminal, wherein the drive transistor has a gate, and wherein the first transistor is coupled between the data input terminal and the gate.

6. The display pixel defined in claim 5 further comprising a positive power supply terminal, wherein the gate is connected to a first node and wherein the fourth transistor is coupled between the positive power supply node and a second node.

7. The display pixel defined in claim 6 wherein the first capacitor is coupled between the first node and the second node.

8. The display pixel defined in claim 7 wherein the second capacitor is coupled between the second node and the positive power supply terminal.

9. The display pixel defined in claim 8 wherein the drive transistor is coupled between the second node and the organic light-emitting diode by the fifth transistor.

10. The display pixel defined in claim 9 wherein the organic light-emitting diode has a first terminal coupled to a ground power supply terminal and a second terminal coupled to the fifth transistor and wherein the third transistor is connected to the second terminal.

11. A display pixel, comprising:
an organic light-emitting diode;
first, second, third, fourth, fifth, and sixth transistors, wherein the sixth transistor is a drive transistor that has a threshold voltage and that supplies a current to the organic light-emitting diode; and
a capacitor, wherein the drive transistor has a gate, wherein the capacitor is coupled to the gate, wherein the first, second, third, fourth, and fifth transistors receive control signals during operation of the display pixel that compensate for variations in the threshold voltage of the drive transistor.

12. The display pixel defined in claim 11 wherein the first, second, third, fourth, and fifth transistors are p-type transistors.

13. The display pixel defined in claim 12 wherein the drive transistor is a p-type transistor.

14. The display pixel defined in claim 11 further comprising:
a data input terminal that receives data for the display pixel; and
a reference voltage terminal that receives a reference voltage.

15. The display pixel defined in claim 14 wherein the drive transistor has a gate, wherein a first terminal of the capacitor is connected to a first node, wherein a second terminal of the capacitor is connected to a second node, wherein the first node is connected to the gate, and wherein the first transistor is coupled between the data input terminal and the second node.

16. The display pixel defined in claim 15 wherein the third transistor is coupled between the reference voltage terminal and the second node.

17. The display pixel defined in claim 16 wherein the drive transistor has a drain and wherein the second transistor is coupled between the drain and the first node.

18. The display pixel defined in claim 17 wherein the fourth transistor is coupled between the drain and the organic light-emitting diode and wherein the fifth transistor is coupled between the reference voltage terminal and the organic light-emitting diode.

19. A display, comprising:
display driver circuitry that produces data and control signals; and
an array of display pixels for displaying the data in response to the control signals, wherein each display pixel includes an organic light-emitting diode, includes at least five p-type transistors, and includes at least two capacitors.

20. The display defined in claim 19 wherein the drive transistor has a source and a gate, wherein a first of the capacitors is connected between the source and the gate of the drive transistor, and wherein a second of the capacitors has a terminal connected to the source of the drive transistor.
